(19) United States
(12) Patent Application Publication
(10) Pub. No.: US 2008/0199265 A1
(43) Pub. Date: Aug. 21, 2008

(54) End Mill

(76) Inventors: Yasuo Hamatake, Aichi (JP); Jiro Osawa, Aichi (JP); Yoshiaki Adachi, Aichi (JP)

Correspondence Address: Muramatsu & Associates, 114 Pacifica, Suite 310, Irvine, CA, 92618, US

(21) Appl. No.: 11/665,730

(22) PCT Filed: Oct. 25, 2004
(86) PCT No.: PCT/JP04/15799

§ 371 Date: Dec. 21, 2007

(51) Int. Cl. B23C 5/10

(52) U.S. Cl. 407/54

(57) ABSTRACT

An end mill enable to suppress vibrations in cutting and improve chip discharging property, thereby achieving both high cutting efficiency and long tool life. The first clearance angle t₁ of outer peripheral edges of the end mill 1 is set to a range of more than 0° to approximately 3°, the first clearance width α₁ of the outer peripheral edges is set to a range of approximately 0.005D or more to approximately 0.03D where the outside diameter is D, and a helix angle θ is set to an equal value for all the outer peripheral edges in a range of approximately 35° or more to approximately 40°. As a result, the vibration in cutting can be suppressed, and the chip discharging property can be improved.

### TECHNICAL FIELD

The present invention relates to an end mill. More specifically, the present invention relates to an end mill enabling the suppression of vibration in cutting and providing long life.

### BACKGROUND ART

Generally, vibration in cutting using an end mill causes roughening on a work surface. As techniques suppressing the vibration of the end mill (e.g., square end mill) having helical edges, there have been proposed techniques such as variable lead (unequal helix) making the helix angle of the helical edges different and unequal spacing forming the helical edges in the circumferential direction at an unequal spacing.

For example, Japanese Patent Application Laid-Open No. S63-89212 (Patent Document 1) discloses an end mill in which plural cutting edges provide unequal helix and end cutting edges continuous with ends of the cutting edges and extended in the radial direction on the distal face of the end mill are formed in the circumferential direction of the main body of the end mill at an equal spacing, thereby obtaining a satisfactory finished surface.

[Patent Document 1] Japanese Patent Application Laid-Open No. S63-89212 (the second line from the bottom in the upper left section to the 14th line in the upper right section on page 2)

### DISCLOSURE OF THE INVENTION

### Problem to be Solved by the Invention

When the end mill provides variable lead (unequal helix) and unequal spacing, the position balance of the cutting edges and the chip discharging flutes is bad. Chip discharging property is reduced. As a result of the reduced chip discharging property, abrasion and chipping easily occur in the end mill so that tool life is shortened. These problems are significant in cutting at high speed, making provision of both improvement in cutting efficiency and cost reduction difficult.

The present invention has been made to address the above problems and an object of the present invention is to provide an end mill enabling the suppression of vibration in cutting and the improvement of chip discharging property to provide both high cutting efficiency and long tool life.

### Means for Solving the Problem

To achieve the object, an end mill according to claim 1 having a tool main body rotated about its axis, plural helical flutes recessed to be helical about the axis of the tool main body, plural outer peripheral edges formed along the helical flutes, and end cutting edges continuous with the outer peripheral edges and formed at the bottom portion of the tool main body, wherein: the first clearance angle of the outer peripheral edges is set to a range of more than 0° to approximately 3°; the first clearance width of the outer peripheral edges is set to a range of approximately 0.005D or more to approximately 0.03D where the outside diameter is D; and a helix angle is set to an equal value for all the outer peripheral edges in a range of approximately 35° or more to approximately 40°.

In the end mill of claim 2 which is the end mill according to claim 1, the maximum height roughness on the surfaces of the helical flutes is approximately 2 μm or less.

The end mill of claim 3 which is the end mill according to claim 2, further includes gashes forming cutting faces of the end cutting edges, the maximum height roughness on the surfaces of the gashes being approximately 2 μm or less.

### EFFECT OF THE INVENTION

In the end mill according to claim 1, the first clearance angle of plural outer peripheral edges formed along plural helical flutes recessed to be helical about the axis of a tool main body rotated about its axis is set to a range of more than 0° to approximately 3°.

The first clearance angle of the outer peripheral edges is set to approximately 3° or less. The vibration in cutting can be suppressed. When cutting speed and feed speed are increased, the roughening on the work surface can be prevented. The cutting efficiency can be improved.

The first clearance angle is more than 0°. The clearance faces are not contacted with the work surface in cutting. When cutting speed and feed speed are increased, the roughening on the work surface can be prevented. The cutting efficiency can be improved.

The first clearance width of the outer peripheral edges is set to a range of approximately 0.005D or more to approximately 0.03D where the outside diameter is D. The first clearance width of the outer peripheral edges is set to approximately 0.005D or more. Burrs in slotting at high speed can be prevented. A satisfactory finished product can be obtained with high cutting efficiency.

The first clearance width of the outer peripheral edges is set to approximately 0.03D or less where the outside diameter is D. The contact of the first clearance faces with the work surface can be prevented. The vibration in cutting can be suppressed. When cutting speed and feed speed are increased, the roughening on the work surface can be prevented. The cutting efficiency can be improved.

A helix angle of the outer peripheral edges is set to a range of approximately 35° or more to approximately 40°. The helix angle of the outer peripheral edges is set to approximately 35° or more. The components in the direction perpendicular to the axis in cutting resistance of the outer peripheral edges received from the work surface cannot be excessively large. The vibration in cutting can be suppressed. When cutting speed and feed speed are increased, the roughening on the work surface can be prevented. The cutting efficiency can be improved.

The helix angle of the outer peripheral edges is set to approximately 40° or less. The components in the axis direction in cutting resistance of the outer peripheral edges received from the work surface cannot be excessively large. When a workpiece having high hardness is cut, that is, when the outer peripheral edges are subject to severe cutting resistance, the end mill can be prevented from falling off from the collet of a cutting machine.

When the end mill falls off from the collet in cutting, the working hour is wasted. When cutting is performed again, the position of the work surface and the cutting edges of the end mill is changed, making it difficult to obtain a satisfactory finished surface. The end mill can be prevented from falling off from the collet. The cutting efficiency can be improved.

The helix angle is formed to be an approximately equal value for all the outer peripheral edges. The chip discharging property is good. Abrasion and chipping in the end mill can be prevented. The life of the end mill can be increased.

In the end mill according to claim 2, in addition to the effect of the end mill according to claim 1, the maximum height roughness on the surfaces of the helical flutes is approximately 2 μm or less. The maximum height roughness on the surfaces of the helical flutes is approximately 2 μm or less. The chip discharging property in cutting can be improved. Abrasion and chipping in the end mill can be prevented. The life of the end mill can be increased.

In the end mill according to claim 3, in addition to the effect of the end mill according to claim 2, the maximum height roughness on the surfaces of gashes forming cutting faces of the end cutting edges is approximately 2 μm or less. The maximum height roughness not only on the surfaces of the helical flutes but also on the surfaces of the gashes is approximately 2 μm or less. The chip discharging property can be improved more effectively. Abrasion and chipping in the end mill can be prevented more effectively. The life of the end mill can be further increased.

### BRIEF DESCRIPTION OF DRAWINGS

FIG. 1 is a front enlarged view of the edge parts of an end mill according to an embodiment of the present invention.

FIG. 2 is a side view of the end mill viewed in the direction of arrow II of FIG. 1.

FIG. 3 is a cross-sectional view of an outer peripheral edge of the end mill in the direction perpendicular to the axis.

FIG. 4 is a diagram showing the results in which three-component waveforms in cutting resistance obtained from a cutting examination are numerical.

FIG. 5 is a diagram showing the results of a durability examination.

### DESCRIPTION OF REFERENCE NUMERALS

| | |
|---|---|
| 1 | end mill |
| 2 | tool main body |
| 3a-3d | chip discharging flute (helical flute) |
| 4a-4d | outer peripheral edge |
| 5a-5d | end cutting edge |
| 6a-6d | gash |
| α₁ | first clearance angle |
| t₁ | first clearance width |

### Best Mode for Carrying Out the Invention

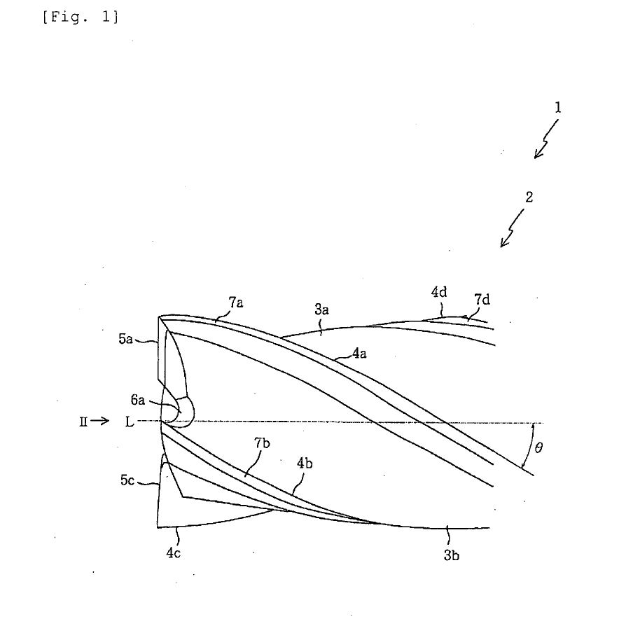

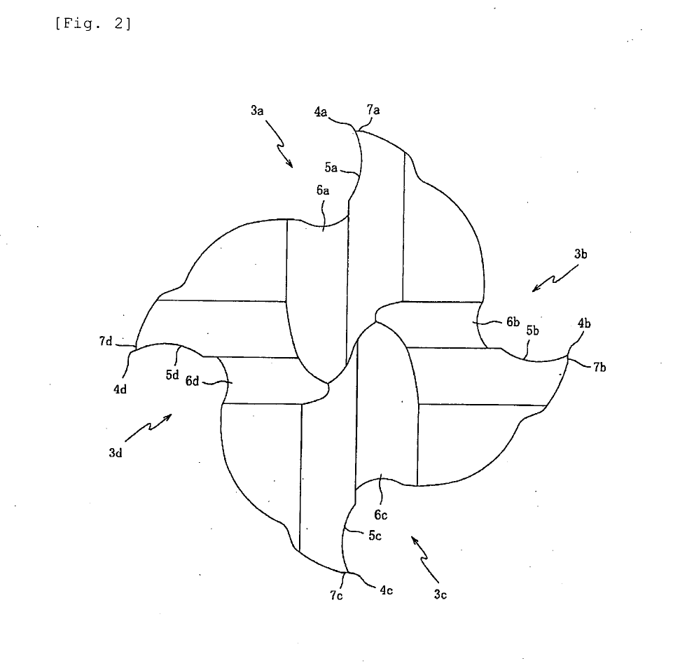

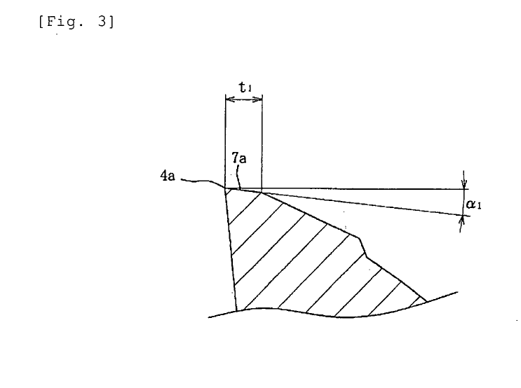

An embodiment of the present invention will be described below based on the drawings. FIG. 1 is a front enlarged view of an end mill 1 according to an embodiment of the present invention, FIG. 2 is a side view of the end mill 1 viewed in the direction of arrow II of FIG. 1, and FIG. 3 is a cross-sectional view of an outer peripheral edge 4a of the end mill 1 in the direction perpendicular to the axis. The overall construction of the end mill 1 will be described with reference to FIGS. 1 to 3.

The end mill 1 is a square end mill of a solid type having a tool main body 2 having an axis L. The tool main body 2 is made of a sintered hard alloy obtained by pressurizing and sintering tungsten carbide (WC), and mainly has one end formed with chip discharging flutes 3a-3d, outer peripheral edges 4a-4d, end cutting edges 5a-5d, gashes 6a-6d, and first clearance faces 7a-7d of the outer peripheral edges 4a-4d, and the other end formed with a cylindrical shank (not shown).

In this embodiment, titanium nitride aluminum (TiAlN) is coated onto the outer peripheral edges 4a-4d and the end cutting edges 5a-5d to improve heat resistance and weld resistance in cutting of a material having high hardness.

The end mill 1 is attached via the collet (not shown) to a cutting machine such as a machining center, and is rotatably driven about the axis L to be moved for performing cutting.

The chip discharging flutes 3a-3d produce, store, and discharge chips during cutting, and are recessed to be helical about the axis L of the tool main body 2. It is preferable that the surfaces of the chip discharging flutes 3a-3d be lapped to improve the chip discharging property. In this case, it is preferable that the maximum height roughness Rz on the surfaces of the lapped chip discharging flutes 3a-3d be approximately 2 μm or less.

The term “maximum height roughness Rz” is the standard about surface roughness defined by JIS B0601-2001, and is a value determined by extracting a reference length from a roughness curve in the direction of its average line to add a height to the top from the average line of the extracted portion to a depth to the bottom therefrom.

The maximum height roughness Rz on the surfaces of the chip discharging flutes 3a-3d is set to approximately 2 μm or less. The chip discharging property in cutting using the end mill 1 can be improved. Abrasion and chipping in the outer peripheral edges 4a-4d and the end cutting edges 5a-5d of the end mill 1 can be prevented. The life of the end mill 1 can be increased.

In this embodiment, the maximum height roughness Rz of the chip discharging flutes 3a-3d is set to 1 μm. These values can be appropriately changed according to the cutting conditions.

Four outer peripheral edges 4a-4d are cutting edges formed on the outer peripheral side of the tool main body 2 and are formed in the ridge portions in which the chip discharging flutes 3a-3d and the first clearance faces 7a-7d cross each other. In this embodiment, the outer peripheral shape of the end mill 1 is formed as an eccentric relief. Without being limited to this, the outer peripheral shape of the end mill 1 can be formed in a flat shape or as a cone cable relief.

It is preferable that a helix angle θ be equal for all the outer peripheral edges 4a-4d, that is, that the helix angle θ provide equal helix. The helix angle θ of the outer peripheral edges 4a-4d provides equal helix. The chip discharging property is good. Abrasion and chipping in the end mill 1 can be prevented. The life of the end mill 1 can be increased.

It is preferable that the helix angle θ be set to a range of approximately 35° or more to approximately 40°. The helix angle θ is set to 35° or more. The components in the direction perpendicular to the axis in cutting resistance of the outer peripheral edges 4a-4d received from the work surface cannot be excessively large. The vibration in cutting can be suppressed. When cutting speed and feed speed are increased, the roughening on the work surface can be prevented. The cutting efficiency can be improved.

The helix angle θ is set to approximately 40° or less. The components in the axis direction in cutting resistance of the outer peripheral edges 4a-4d received from the work surface cannot be excessively large. When a workpiece having high hardness is cut, that is, when the outer peripheral edges 4a-4d are subject to severe cutting resistance, the end mill 1 can be prevented from falling off from the collet of the cutting machine.

When the end mill 1 falls off from the collet in cutting, the working hour is wasted. When cutting is performed again, the position of the work surface and the cutting edges of the end mill 1 is changed, making it difficult to obtain a satisfactory finished surface. The end mill 1 can be prevented from falling off from the collet of the cutting machine. The cutting efficiency can be improved.

In this embodiment, the helix angle θ is set to be 38°. In this embodiment, the outside diameter D of the outer peripheral edges 4a-4d is set to be 10 mm. These values can be appropriately changed according to the cutting conditions.

The first clearance faces 7a-7d are clearance faces formed just after the outer peripheral edges 4a-4d (see FIG. 3). In FIG. 3, as a representative example of the first clearance faces 7a-7d formed just after the outer peripheral edges 4a-4d, the section in the direction perpendicular to the axis including the first clearance face 7a formed just after the outer peripheral edge 4a is shown. The first clearance faces 7b-7d formed just after the remaining three outer peripheral edges 4b-4d have the same shape.

Here, it is preferable that the width of the first clearance faces 7a-7d (hereinafter, abbreviated as the “first clearance width”) t₁ be formed in a range of approximately 0.005D or more to approximately 0.03D where the outside diameter is D.

The first clearance width t₁ is set to approximately 0.005D or more where the outside diameter is D. Burrs in slotting at high speed can be prevented. A satisfactory finished product can be obtained with high cutting efficiency.

The first clearance width t₁ is set to approximately 0.03D or less where the outside diameter is D. The contact of the first clearance faces 7a-7d with the work surface can be prevented. When cutting speed and feed speed are increased, the vibration in cutting can be suppressed. When cutting speed and feed speed are increased, the roughening on the work surface can be prevented. The cutting efficiency can be improved.

In this embodiment, the first clearance width t₁ is set to 0.2 mm (=0.02D). This value can be appropriately changed according to the cutting conditions.

It is preferable that the tilt of the first clearance faces 7a-7d (hereinafter, abbreviated as the “first clearance angle”) α₁ with respect to the cut finished surface be formed in a range of more than approximately 0° to approximately 3°.

The first clearance angle α₁ is approximately 3° or less. The vibration in cutting can be suppressed. When cutting speed and feed speed are increased, the roughening on the work surface can be prevented. The cutting efficiency can be improved.

The first clearance angle α₁ is more than 0°. The contact of the first clearance faces 7a-7d with the work surface in cutting can be prevented. When cutting speed and feed speed are increased, the roughening on the work surface can be prevented. The cutting efficiency can be improved.

In this embodiment, the first clearance angle α₁ is set to 2°. This value can be appropriately changed according to the cutting conditions.

The end cutting edges 5a-5d are cutting edges continuous with the outer peripheral edges 4a-4d, respectively, and are formed at the bottom portion (on the left side of FIG. 1) of the tool main body 2. As shown in FIGS. 1 and 2, the end cutting edges 5a-5d are formed with the gashes 6a-6d, respectively. As shown in FIG. 2, the gashes 6b and 6d are formed to the back of the end cutting edges 5a and 5c, respectively. The gashes 6b and 6d are formed to exceed the end cutting edges 5b and 5d, respectively.

As described above, it is preferable that the surfaces of the chip discharging flutes 3a-3d be lapped to improve the chip discharging property. It is also preferable that the surfaces of the gashes 6a-6d be lapped to further improve the chip discharging property. In this case, as in the surfaces of the chip discharging flutes 3a-3d, it is preferable that the maximum height roughness Rz be approximately 2 μm or less.

The maximum height roughness Rz not only on the surfaces of chip discharging flutes 3a-3d but also on the surfaces of the gashes 6a-6d is approximately 2 μm or less. The chip discharging property in cutting using the end mill 1 can be effectively improved. Abrasion and chipping in the outer peripheral edges 4a-4d and the end cutting edges 5a-5d of the end mill 1 can be effectively prevented. The life of the end mill 1 can be increased effectively.

In this embodiment, the maximum height roughness Rz of the gashes 6a-6d is set to 1 μm. These values can be appropriately changed according to the cutting conditions.

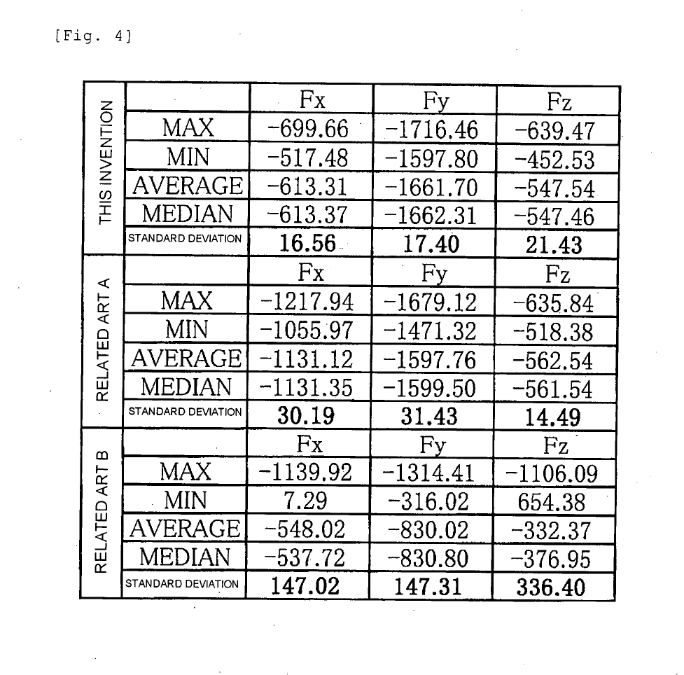

The results of a cutting examination which has been performed using the thus-constructed end mill 1 will be described with reference to FIG. 4. The cutting examination is an examination measuring three-component waveforms in cutting resistance when performing 1D slotting using the end mill 1, that is, slotting using the end mill 1 to cut a workpiece into the depth corresponding to the outside diameter D. FIG. 4 is a diagram showing the results in which the three-component waveforms in cutting resistance obtained from the cutting examination are numerical.

Detailed specifications of the cutting examination include workpiece: JIS-SUS304, machine to be used: machining center, cutting form: 1D slotting, cutting oil material: water soluble, cutting speed: 90 m/min, and feed speed: 550 mm/min. A dynamometer manufactured by Kistler is used for measuring the three-component waveforms in cutting resistance.

The above-described end mill 1 (hereinafter, called “this invention”) is used for the cutting examination.

An end mill (hereinafter, called the “related art A”) provides variable lead in which the first clearance angle of the outer peripheral edges is 11° and the helix angles of the outer peripheral edges are 35° and 38°, and is constructed such that the chip discharging flutes and the gashes are not lapped. An end mill (hereinafter, called the “related art B”) is constructed such that the first clearance angle of the outer peripheral edges is 110, the helix angle of the outer peripheral edges is 45° (equal helix), and the chip discharging flutes and the gashes are not lapped. For comparison, the similar cutting examination is performed to the related art A and the related art B.

The related art B cannot be cut under the cutting conditions. The cutting conditions are lowered to perform the cutting examination with a cutting speed of 70 m/min and a feed speed of 268 mm/min. This invention, the related art A, and the related art B are different only in the numerical values of the above-described parameters, and are similar in the material or dimensions.

FIG. 4 lists five kinds of numerical values of each of three-component (Fx, Fy, Fz) waveforms of cut resistance for this invention, the related art A, and the related art B in the section of 10 to 20 seconds after the start of cutting, specifically, the maximum value of amplitude (“MAX” in FIG. 4), the minimum value of amplitude (“MIN” in FIG. 4), the average of amplitude (“AVERAGE” in FIG. 4), the median of amplitude (“MEDIAN” in FIG. 4), and the standard deviation of amplitude (“standard deviation” in FIG. 4).

Of these values, the standard deviation of amplitude is variation in amplitude of the cutting resistance waveform, that is, a value as a standard showing how large vibration in cutting is. Specifically, as the standard deviation is smaller, the vibration in cutting is reduced.

As shown in FIG. 4, the standard deviations when using this invention are 16.56 for Fx, 17.40 for Fy, and 21.43 for Fz.

As shown in FIG. 4, the standard deviations of amplitude using the related art A are 30.19 for Fx, 31.43 for Fy, and 14.49 for Fz. As shown in FIG. 4, the standard deviations of amplitude using the related art B are 147.02 for Fk, 147.31 for Fy, and 336.40 for Fz.

By comparing the standard deviations of this invention with the standard deviations of the related art B shown in FIG. 4, the amplitudes of the three components (Fx, Fy, Fz) in cutting resistance of this invention are approximately 0.1 times, approximately 0.1 times, and approximately 0.06 times larger than the amplitudes of the three components (Fx, Fy, Fz) in cutting resistance of the related art B, respectively. The cutting conditions of the related art B are lowered. It is found that the vibration in cutting using this invention can be improved markedly as compared with that of the related art B.

By comparing the standard deviations of this invention with the standard deviations of the related art A shown in FIG. 4, the amplitudes of the three components (Fx, Fy, Fz) in cutting resistance of this invention are approximately 0.6 times, approximately 0.6 times, and approximately 1.5 times larger than the amplitudes of the three components (Fx, Fy, Fz) in cutting resistance of the related art A, respectively. The variation in amplitude of the Fz component of this invention is larger than that of the related art A. When the three components in cutting resistance are totally observed, the vibration in cutting of this invention can be suppressed as compared with that of the related art A.

In this invention, the helix angle θ of the outer peripheral edges 4a-4d is set to a range of approximately 35° or more to approximately 40°. The vibration in cutting can be suppressed. The first clearance angle α₁ is set to a range of more than 0° to approximately 3°. The vibration in cutting can be suppressed. By these multiplicative effects, the vibration in cutting can be suppressed effectively as compared with that of the related art A and the related art B.

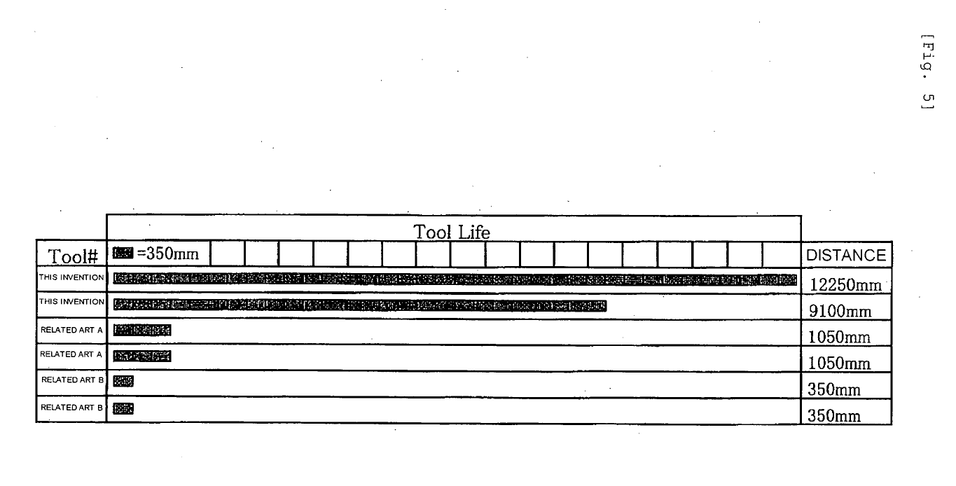

A durability examination when cutting is performed under the cutting conditions will be described with reference to FIG. 5. In the durability examination, this invention, the related art A, and the related art B in new tool state perform cutting to the cutting distance of 350 mm under the cutting conditions to measure whether or not there is chipping in the outer peripheral edges or the end cutting edges (the outer peripheral edges 4a-4d or the end cutting edges 5a-5d in this invention). Then, the sum of the cutting distances (hereinafter, called the “total cutting distance”) until chipping is found is measured.

FIG. 5 is a diagram showing the results of the durability examination. In this embodiment, the durability examination is performed to this invention, the related art A, and the related art B twice, respectively. FIG. 5 shows the first measured result in the upper section and the second measured result in the lower section for each of this invention, the related art A, and the related art B.

As shown in FIG. 5, in this invention, chipping is found at the total cutting distance of 12,250 mm in the first durability examination, and chipping is found at the total cutting distance of 9,100 mm in the second durability examination. The average value of these two durability examinations is 10,675 mm.

In the related art A, large chipping is found at the total cutting distance of 1,050 mm in both the first and second durability examinations. The average value of the durability examinations is 1,050 mm. In the related art B, large chipping is found at the total cutting distance of 350 mm in both the first and second durability examinations. The average value of the durability examinations is 350 mm.

These results show that the durability of this invention can be improved approximately 10 times higher than that of the related art A, and that the durability of this invention can be improved approximately 31 times higher than that of the related art B.

In this invention, the maximum height roughness Rz on the surfaces of the chip discharging flutes 3a-3d is approximately 2 μm or less to improve the chip discharging property. Abrasion and chipping in the outer peripheral edges 4a-4d and the end cutting edges 5a-5d can be prevented. The life of the end mill 1 can be increased. In this case, the maximum height roughness Rz on the surfaces of the gashes 6a-6d is approximately 2 μm or less to effectively improve the chip discharging property. The tool life of the end mill 1 can be increased more effectively.

The helix angle θ of the outer peripheral edges 4a-4d provides equal helix. The chip discharging property can be improved. The life of the end mill 1 can be increased.

As described above, in the end mill 1 (this invention) of this embodiment, the first clearance angle α₁ of the first clearance faces 7a-7d of the outer peripheral edges 4a-4d is set to a range of more than 0° to approximately 3°. The vibration in cutting can be suppressed. When cutting speed and feed speed are increased, the roughening on the work surface can be prevented. The cutting efficiency can be improved.

The helix angle θ of the outer peripheral edges 4a-4d is set to a range of approximately 35° or more to approximately 40°. The vibration in cutting can be suppressed. When cutting speed and feed speed are increased, the roughening on the work surface can be prevented. The cutting efficiency can be improved.

The first clearance width t₁ of the first clearance faces 7a-7d of the outer peripheral edges 4a-4d is set to a range of 0.005D or more to 0.03D where the outside diameter is D. Burrs in cutting can be prevented. The contact of the first clearance faces 7a-7d with the work surface can be prevented. When cutting speed and feed speed are increased, a satisfactory finished product can be obtained.

The maximum height roughness Rz on the surfaces of the chip discharging flutes 3a-3d is approximately 2 μm or less. The chip discharging property in cutting can be improved. Abrasion and chipping in the outer peripheral edges 4a-4d and the end cutting edges 5a-5d of the end mill 1 can be prevented. The life of the end mill 1 can be increased.

The maximum height roughness Rz on the surfaces of the gashes 6a-6d is approximately 2 μm or less. The chip discharging property in cutting can be improved. The life of the end mill 1 can be increased more effectively.

The helix angle θ of the outer peripheral edges 4a-4d provides equal helix. The chip discharging property is good. Abrasion and chipping in the end mill can be prevented. The life of the end mill can be increased.

The present invention is described above based on the embodiment. The present invention is not limited to the above embodiment and it is possible to easily guess that various improvements and changes can be made within the scope without departing from the purport of the present invention.

In the above embodiment, the first clearance angle α₁ of the outer peripheral edges 4a-4d is set to a range of more than 0° to approximately 3°. The vibration in cutting can be suppressed. Not only the first clearance angle α₁ of the outer peripheral edges 4a-4d but also the first clearance angle of the first clearance faces provided just after the end cutting edges 5a-5d is set to a range of more than 0° to approximately 3°. It is possible to easily guess that the vibration in cutting can be suppressed.

In the above embodiment, the first clearance width t₁ of the outer peripheral edges 4a-4d is set to a range of 0.005D or more to 0.03D where the outside diameter is D. When cutting speed and feed speed are increased, a satisfactory product can be obtained. Not only the first clearance width t₁ of the outer peripheral edges 4a-4d but also the first clearance width of the first clearance faces provided just after the end cutting edges 5a-5d is set to a range of 0.005D or more to 0.03D where the outside diameter is D. Burrs in slotting can be prevented. The contact of the first clearance faces of the end cutting edges 5a-5d with the work surface can be prevented. It is possible to easily guess that when cutting speed and feed speed are increased, a satisfactory finished product can be obtained.

In the above embodiment, a square end mill is shown as the end mill 1. Without being limited to the square end mill, it is possible to easily guess that any end mill having helical edges as outer peripheral edges can be applied as a ball end mill or a radius end mill.

In the above embodiment, the end mill 1 has four cutting edges (the outer peripheral edges 4a-4d and the end cutting edges 5a-5d). It is possible to easily guess that the end mill 1 is constructed as a multi-flute end mill except that the number of cutting edges is four.

1. An end mill comprising:
a tool main body rotated about its axis;
a plurality of helical flutes recessed to be helical about the axis of the tool main body;
a plurality of outer peripheral edges formed along the helical flutes; and
end cutting edges continuous with the outer peripheral edges and formed at the bottom portion of the tool main body,
wherein the first clearance angle of the outer peripheral edges is set to a range of more than 0° to approximately 3°;
the first clearance width of the outer peripheral edges is set to a range of approximately 0.005D or more to approximately 0.03D where the outside diameter is D;
the first clearance angle of the first clearance faces provided just after the end cutting edges is set to a range of more than 0° to approximately 3°;
the first clearance width of the first clearance faces provided just after the end cutting edges is set to a range of approximately 0.005D or more to approximately 0.03D where the outside diameter is D; and
a helix angle is set to an equal value for all the outer peripheral edges in a range of approximately 35° or more to approximately 40°.

2. The end mill according to claim 1, wherein the surfaces of the helical flutes are lapped, and the maximum height roughness on the surfaces thereof is approximately 2 μm or less.

3. The end mill according to claim 2, further comprising:
gashes forming cutting faces of the end cutting edges,
wherein the surfaces of the gashes are lapped; and
the maximum height roughness on the surfaces thereof is approximately 2 μm or less.
